(19) United States
(12) Patent Application Publication
(10) Pub. No.: US 2020/0171401 A1
(43) Pub. Date: Jun. 4, 2020

(54) ELONGATE STRIP FORMING A TOY BUILDING BLOCK BASE

(71) Applicant: CHROME CHERRY DESIGN STUDIO (PTY) LTD, Cape Town OT (ZA)

(72) Inventors: Anine Kirsten, Cape Town (ZA); Max Basler, Cape Town (ZA); Jaco Kruger, Gordons Bay (ZA); Séamus Dougal Maclennan, St Simons Island, GA (US)

(73) Assignee: CHROME CHERRY DESIGN STUDIO (PTY) LTD, Cape Town, OT (ZA)

(21) Appl. No.: 16/462,087

(22) PCT Filed: Nov. 23, 2017
(86) PCT No.: PCT/IB2017/057363

§ 371 Date: May 17, 2019

(30) Foreign Application Priority Data
Nov. 24, 2016 (GB) 1619927.5
Jun. 23, 2017 (ZA) 2017/04276
Jul. 28, 2017 (ZA) 2017/05134

(51) Int. Cl. A63H 33/08; B29C 48/35; B29C 48/00; B29C 48/21; B29C 65/48

(52) U.S. Cl. CPC A63H 33/086; B29C 48/35; B29C 48/0011; B29K 2075/00; B29C 48/21; B29C 65/48; B29C 48/0022

(57) ABSTRACT

A toy building block base comprises a flexible elongate body strip having a first major surface along a length of the strip that includes either an array of projections extending from the first major surface or an array of recesses set into the first major surface. The projections or recesses form a mating arrangement for co-operant toy building blocks. An opposite, second major surface has an adhesive by which the body strip can be attached to a support surface. The body strip includes no more than four projections or recesses across its width and has a length of at least 200 mm. The entire body strip is made from a homogenous flexible plastics material.

### CROSS-REFERENCE TO RELATED APPLICATIONS

This application claims priority from United Kingdom patent application number 1619927.5 filed on 24 Nov. 2016, South African provisional patent application number 2017/04276 filed on 23 Jun. 2017, and South African provisional patent application number 2017/05134 filed on 28 Jul. 2017, all of which are incorporated by reference herein.

### FIELD OF THE INVENTION

This invention relates to an elongate strip forming a toy building block base and, more particularly, one that is compatible with existing substantially rigid toy building blocks.

Existing toy building blocks may include many variants but typically include at least basic building blocks that are of rectangular parallelepiped shape with multiple projections extending from one surface that could be regarded as the male mating surface and an opposite female mating surface. The male mating surface typically forms a top surface in use, and the female mating surface a bottom surface so that the blocks can be frictionally engaged or clipped together with compatible building blocks to form structures of a chosen size and shape.

As a general rule, two rows of squat projections or accommodating recesses are provided across the width on a surface of a standard full width building block whilst a single row of squat projections or accommodating recesses is provided on the surface of a standard half width building block. The lengths of a standard full width building block and a standard half width building block generally vary from one to eight squat projections or accommodating recesses in length and up to sixteen that is the longest of which applicant is aware. Numerous special external shapes of building blocks are provided to create replica people, figures, characters and structures but all of them have, as a general rule, cooperating projections and recesses to enable their temporary interconnection with the basic toy building blocks.

### BACKGROUND TO THE INVENTION

Typically the toy building block projections are squat approximately cylindrical projections arranged in aligned rows extending along a length of the building block and the recesses are formed by a space between side and end walls of a hollow block and one or more surfaces of locking formations such as cylindrical formations extending from an inside of a top wall of the block to a bottom surface plane of the block. The squat projections are, in an operative condition, engaged by the inner surface of the sidewalls and any adjacent end walls and a surface of the locking formations. The sidewalls and end walls are, other than for specialist building blocks, smooth.

Probably the most common toy building block range of this general nature, as far as applicant is aware, is that sold under the trade name LEGO® which is a registered trademark of LEGO JURIS A/S of Denmark. However, other compatible toy building blocks are available such as MEGA BLOKS® a trade mark of MEGA BLOK INC of Canada (working with MATTEL® and FISHER PRICE®) and KRE-O® construction blocks marketed by HASBRO® of Korea.

It should be noted that the scope of this invention is not to be interpreted as being limited in any way to use in conjunction with any particular range of toy building blocks and the bases of this invention could be used with any of the above or other types of toy building blocks of the same general nature, or even as a part of a custom toy building block set.

Prior art toy building block sets do have a facility for building replica people, figures, characters and structures in relation to each other in the form of a separate base sheet having formations thereon for receiving building blocks in frictional or clipping relationship relative to the base sheet.

These base sheets are of standard sizes and the sizes of base sheets to be used are limited in number and must be selected or acquired according to the purpose.

Also, there are available on the market, square 10 inch (254 mm) by 10 inch (254 mm) adhesive “LEGO® compatible tiles” that carry on their obverse surface an array of formations suitable for receiving toy building blocks of the general type outlined above so that an entire structure can be built on one or a plurality of juxtaposed aligned tiles. The tiles carry multiple projections arranged so that edge to edge location of the tiles results in a continuous series of the formations being created on the surface at the joints between tiles over a surface to which the tiles are adhered by means of an adhesive with the outer edges in alignment. The adhesive is pressure sensitive and selected so that tiles may be releasably adhesively secured to any suitable support surface and can be used for supporting replica people, characters and structures with the tiles being stuck, for example, on a window, wall, article of furniture, appliance surface or a computer surface, simply by way of example.

MEGA BLOK INC® also provide a base that consists of a number of coplanar sections that are hingedly attached to each other so that a composite flat base of different peripheral shapes can be created.

The versatility of toy building blocks of the general nature outlined above has proved to be exceptionally successful. However, these prior art types of bases are restrictive on certain types of creations that may be applied thereto in particular circumstances.

From the perspective of published prior art, EP 0621062 A2 to Messerschmitt describes a flexible sheet-like base that can follow various contours. However, it does not envisage contours that may twist and turn and would be unsuitable for such applications.

U.S. Pat. No. 9,480,931 to Samo & Elliott describes a variety of different bases both rigid and flexible that have embedded therein at least one elongate member embedded within the base and formed of a different material than that of which the base is made.

DE202013104194 to Sailer describes a floor covering that is not designed to follow any contour other than a flat floor and cannot therefore follow twists and turns.

EP 3005894 to Capboytrading describes a cap having a peak and optionally a display plate on the cap having an array of multiple cylindrical projections to which toy building blocks can be attached in the manner indicated above. There is no suggestion that such a base could follow a contour that twists and turns.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with a first aspect of this invention there is provided a toy building block base comprising a flexible elongate body strip having a first major surface along a length of the strip that includes either an array of projections extending from the first major surface or an array of recesses set into the first major surface, the projections or recesses forming a mating arrangement for co-operant toy building blocks, the body strip having an opposite, second major surface with adhesive by which the body strip can be attached to a support surface, wherein the body strip includes no more than four projections or recesses across its width and has a length of at least 200 mm, the entire body strip being made from a homogenous flexible material.

A further feature provides for the homogenous flexible material to have a durometer value of between 35 and 80 according to the ASTM D2240 standard's type A durometer scale.

The toy building block base may be flexible to be manipulated in multiple axes of deformation which includes torsional deformation involving twisting of the elongate body strip, lateral bending deformation in which the elongate body strip bends in a plane of the body strip, longitudinal bending deformation in which the body strip bends in a direction perpendicular to the plane of the body strip, or any simultaneous combination of these deformations, with co-operant toy building blocks remaining attached to the toy building block base during at least some of such deformations.

Further features provide for the body strip to have a width of between 12 mm and 40 mm and to include two, three or four projections or recesses across its width, preferably two, three or four projections or recesses; and for the body strip to have a thickness defined between the first major surface and second major surface of between 1 mm and 6 mm, preferably between 2.5 mm and 4.4 mm. The thickness is preferably selected to be the same as a corresponding thickness of a plate building block so that the first major surface is at the same height as that of a plate building block placed next to it on a common base or on another toy building block.

Further features provide for the adhesive to be pressure sensitive and releasable to permit the toy building block base to be repositioned on a supporting surface; and for the adhesive to be a pre-formed adhesive layer applied to the toy building block base, in one embodiment in an accommodating shallow flat-bottomed longitudinal recess in the second major surface that receives a major part of the thickness of the pre-formed adhesive layer. The pre-formed adhesive layer may be a double sided adhesive polyurethane strip and may include a removable cover strip on an exposed face pending initial use; and may be of a type that is reusable to permit the toy building block base to be peeled off a surface to which it is stuck and then be stuck onto another surface in reusable manner. In the event that the body strip has a shallow flat-bottomed longitudinal recess, the adhesive layer may have a thickness of from 0.4 mm to 0.8 mm, and the longitudinal recess may have a depth such that an exposed face of the adhesive layer is slightly proud of edges of the elongate body strip.

The toy building block base may have a length within the range of from 200 mm to 3,000 mm, and preferably from 500 mm to 2,500 mm; and may be made as an extrusion of indefinite length that is severed into selected lengths.

Further features provide for the width of the toy building block base to be selected to be the same as that of at least some co-operant toy building blocks in association with which it is intended to be used; and for the durometer value of the flexible material to be from 45 to 65. The toy building block base may be severable by cutting with a cutting instrument such as a pair of household scissors.

In the case of the body strip including an array of regularly spaced recesses set into the first major surface, each recess may be formed by multiple surface zones configured to engage portions of an outer peripheral surface of a projection of a toy building block received therein discontinuously around the peripheral surface of the projection.

In the case of the body strip including an array of regularly spaced projections extending from the first major surface, each projection may have a diameter that is slightly larger than a corresponding recess in a cooperating toy block such that the projection deforms upon being urged into a corresponding recess to create frictional interference between the projection and the cooperating toy block; for the projections to be cylindrical projections; and for each projection to have a flat top and a chamfered or rounded edge between its cylindrical sidewall and its flat top to guide the projection into the corresponding recess. In one example, the projections have an effective outer diameter of 4.95 mm (+/−0.5 mm), a 0.5 mm radius on the chamfered or rounded edge, and a height of 1.8 mm, and are configured to cooperate with toy building blocks that have recesses with a diameter of 4.8 mm.

Further features provide for the first major surface of the body strip to include guide lines that assist a user in cutting the body strip with a cutting instrument such as a pair of scissors. The guide lines may include a set of parallel transverse guide lines that extend at least partway across the width of the body strip at regular spaced intervals between adjacent sets of projections or recesses to assist a user in cutting across the width of the body strip at right angles to the length of the strip. The regular spaced intervals may be between every adjacent projection along the length of the body strip. The guide lines may also include one or more longitudinal guide lines that extend between rows of projections or recesses along the length of the body strip to assist a user in cutting along the length of the body strip.

The guide lines may be formed by grooves in the first major surface of the body strip, and each guide line may include a set of aligned grooves. Each individual groove in the set of grooves may be consistent with one projection or recess.

The toy building block base may be marketed in loose form from bulk packs thereof; individually wrapped form; or in the form of rolls or looped coils thereof of predetermined lengths.

The material from which the toy building block base is made preferably has little plastic memory, and most preferably has substantially no plastic memory. The toy building block base may be made from a plastics material, and the plastics material may be selected from thermoplastic rubber (TPR) or from polymeric organic silicon compounds often referred to as silicones. These plastics materials may be sufficiently deformable to bend but rigid enough to support toy building blocks by inter-engagement of the projections or recesses of the toy building block base with co-operating recesses or projections of a generally rigid toy building block.

Alternatively, the material could be a paper pulp product that is in a flexible matrix that exhibits appropriate properties of flexibility. A pulverized or powdered cork product that is in a flexible matrix could also be used.

As a further alternative, the toy building block base may be composed of a multitude of short lengths of building block base carried by a flexible tape rendering the toy building block base flexible as defined above.

In accordance with a second aspect of this invention there is provided a toy building block set comprising multiple toy building blocks and at least one toy building block base, the toy building blocks each having a first major flat surface with an array of projections forming a male mating surface and an array of recesses forming a female mating surface, with the recesses extending inwards from a second opposite major surface plane spaced from the first major flat surface by a distance defining a height of the toy building block, wherein one toy building block can be frictionally engaged together by at least some of the projections of a male mating surface engaging in recesses in a female mating surface of a compatible building block to form composite structures of a chosen size and shape, wherein the toy building block base includes a flexible elongate body strip having a first major surface along a length of the strip that includes either an array of projections extending from the first major surface or an array of recesses set into the first major surface, the projections or recesses of the toy building block base forming a mating arrangement for the toy building blocks, the body strip having an opposite, second major surface with adhesive by which the body strip can be attached to a support surface, wherein the body strip includes no more than four projections or recesses across its width and has a length of at least 200 mm, the entire body strip being made from a homogenous flexible material.

Further features of the second aspect of the invention provide for at least some of the toy building blocks to have a standard width and the width of the toy building block base to be the same as the standard width of the toy building blocks; and for toy building blocks that are of the thinnest building block of the set thereof to have a standard height and a thickness of the toy building block base to be the same as that standard height. The toy building blocks may be substantially rigid.

In accordance with a third aspect of the invention there is provided a method of manufacturing a toy building block base, the method comprising extruding a plastics material into an elongate body strip using an extrusion die, the plastics material being selected to be flexible and having a durometer value once set of between 35 and 80 according to the ASTM D2240 standard's type A durometer scale, roll forming the elongate body strip by means of a roller mould that presses the elongate body strip to include either an array of projections or an array of recesses in a first major surface along the length of the body strip, and severing the elongate body strip into selected lengths.

Further features provide for the method to include a step of continuously applying an adhesive layer to an opposite, second major surface along the length of the body strip. The adhesive layer may be applied as one surface of a double sided adhesive layer. The body strip may include a shallow flat-bottomed longitudinal recess in the second major surface formed by the extrusion die and the adhesive layer may be located in the shallow flat-bottomed longitudinal recess. The adhesive layer may be made of polyurethane. In the event of a flat-bottomed longitudinal recess being present, it is preferably of a depth such that an exposed face of the adhesive layer is slightly proud of edges of the elongate body strip of the toy building block base. The relevant surface of the elongate body strip may be treated with a solvent in order to prepare it for bonding to the adhesive and enhance the bond of the adhesive to the toy building block base to create a permanent bond. On the other hand, an exposed face of the adhesive layer may be covered with a cover strip pending initial use and the adhesive layer may be reusable in that it can be peeled off a surface to which it is stuck and then be stuck onto another surface in reusable manner.

In accordance with a fourth aspect of this invention there is provided a method of manufacturing a toy building block base, the method comprising placing a strip of flexible plastic material into a compression moulding machine which has an elongate recess in a lower surface that forms one half of a mould cavity and an opposite elongate recess in an upper surface that forms the other half of the mould cavity, the mould cavity having a length of at least 200 mm, with one of the recesses having internal surfaces shaped to mould either an array of projections or an array of recesses into a first major surface of the strip of flexible plastic material, the projections or recesses to form a mating arrangement for co-operant toy building blocks, heating the upper and lower surfaces, pressing the upper and lower surfaces together to compress the strip of material in the mould cavity, opening the moulding machine by moving the upper and lower surface apart, removing the moulded strip, and feeding the moulded strip into a roller which applies an adhesive to an opposite, second major surface of the strip.

In accordance with a fifth aspect of this invention there is provided a method of constructing a toy structure using a toy building block base according to the first aspect, the method comprising attaching the toy building block base to a support surface at two or more zones along the length thereof by contacting the adhesive layer of the toy building block base to the support surface, the toy building block base being unsupported between the two or more zones, and attaching a plurality of co-operant toy building blocks to the toy building block base between the zones in the unsupported areas so as to create a toy structure supported by the toy building block base.

In accordance with a sixth aspect of this invention there is provided a toy building block base comprising an elongate strip of a flexible plastic material having a length of at least 200 mm. The strip has (i) a first major surface that includes an array of regularly spaced projections extending above the first major surface for interconnecting the strip with one or more co-operant toy building blocks, and (ii) a second major surface on a side of the strip opposite from the first major surface. An adhesive is provided on the second major surface for attaching the strip to a supporting surface.

In accordance with a seventh aspect of this invention there is provided a toy building block base comprising an elongate strip of a flexible plastic material having a length of at least 200 mm. The strip has (i) a first major surface that includes an array of regularly spaced recesses set into the first major surface for interconnecting the strip with one or more co-operant toy building blocks, and (ii) a second major surface on a side of the strip opposite from the first major surface. An adhesive is provided on the second major surface for attaching the strip to a supporting surface.

Further features of the fifth and sixth aspects provide that the strip may have either two or four parallel rows of projections or recesses running along the length of the strip, and may be up to 2,000 mm in length. The toy building block base may be severable, for example by cutting with household scissors or tearing by hand. In some embodiments the flexible plastic material from which the strip is made has substantially no plastic memory.

In order that the above and other features of the invention may be more fully understood various embodiments of the invention will now be described, by way of example only, with reference to the accompanying drawings.

### BRIEF DESCRIPTION OF THE DRAWINGS

In the drawings:

FIG. 1 is an isometric view of a length of toy building block base according to an embodiment of the invention;

FIG. 2 is a detail view of the portion indicated as “A” on FIG. 1;

FIG. 3 is similar to FIG. 2 but from a lower perspective and showing a removable cover strip of an adhesive layer that is partly removed;

FIG. 4 is a top view of a length of toy building block base according to an embodiment of the invention;

FIG. 5 is a detail view of a portion of toy building block base indicated as “B” on FIG. 4;

FIG. 6 is a front view of the length of toy building block base of FIG. 4;

FIG. 7 is a cross-section taken through a toy building block base along line I-I in FIG. 6;

FIG. 8 is a detail view of the portion indicated as “C” on FIG. 6;

FIG. 9 is a front view of a length of toy building block base according to an embodiment of the invention having generally rigid toy building blocks attached thereto;

FIG. 10 is an isometric view from above of one form of standard height toy building block;

FIG. 11 is an isometric view from below of the same toy building block illustrated in FIG. 10;

FIG. 12 is a top isometric view of a plate toy building block similar to that illustrated in FIG. 10;

FIG. 13 is an underneath isometric view of the same plate toy building block illustrated in FIG. 12;

FIG. 14 is an end view of a length of toy building block base according to an embodiment of the invention next to which a generally rigid plate toy building block building block has been located on a support surface so that the two can jointly support a transverse generally rigid building block;

FIG. 15 is a three-dimensional view of a roll of the toy building block base according to an embodiment of the invention;

FIG. 16 is an isometric view of a length of looped coils of the toy building block base according to an embodiment of the invention;

FIG. 17 is a three dimensional view of a length of toy building block base that is curved in a generally sinusoidal shape by being bent in a direction perpendicular to a plane of the strip, and is attached to a support surface at two or more zones along its length;

FIG. 18 is a three dimensional view of a length of toy building block base that is curved in a lateral direction in a plane of the strip and is attached to a support surface along its length;

FIG. 19 is a three dimensional view of a length of toy building block base that is attached around a cylindrical object in a spiraling configuration;

FIG. 20 is an isometric view of a somewhat shorter length of toy building block base that is attached to two separate support surfaces at its ends and is unsupported between its ends;

FIG. 21 is a top view of an embodiment of toy building block base according to an embodiment of the invention having an array of complementary recesses serving as a female mating surface;

FIG. 22 is an isometric view of the toy building block base of FIG. 21;

FIG. 23 is a cross-section taken through the toy building block base taken along line II to II in FIG. 21;

FIG. 24 is an isometric view of an alternative embodiment of a toy building block base having an array of complementary recesses serving as a female mating surface;

FIG. 25 is three dimensional view of a further alternative embodiment of a toy building block base having an array of complementary recesses serving as a female mating surface;

FIG. 26 is an isometric view of a yet further alternative embodiment of a toy building block base having an array of complementary recesses serving as a female mating surface;

FIG. 27 is an isometric view of a variation of toy building block base according to an embodiment of the invention having four rows of cylindrical projections;

FIG. 28 is an isometric view of a variation of toy building block base which does not include any guide lines;

FIG. 29 is a front view of a length of toy building block base according to an embodiment of the invention in which living hinges are formed between sets of projections;

FIG. 30 is a front view of a construction of toy building block base composed of a multitude of short lengths of toy building block base carried by a flexible tape;

FIG. 31 is an isometric view of a machine that includes an extrusion die and a roller mould for manufacturing two lengths of toy building block base side-by-side;

FIG. 32 is a schematic side view of the machine of FIG. 31;

FIG. 33 is an alternative machine that includes an extrusion die and a roller mould for manufacturing one length of toy building block base that has four rows of cylindrical projections;

FIG. 34 is an isometric view from above of a compression moulding machine for manufacturing lengths of toy building block base; and

FIG. 35 is an isometric view from below of the machine of FIG. 34.

### DETAILED DESCRIPTION WITH REFERENCE TO THE DRAWINGS

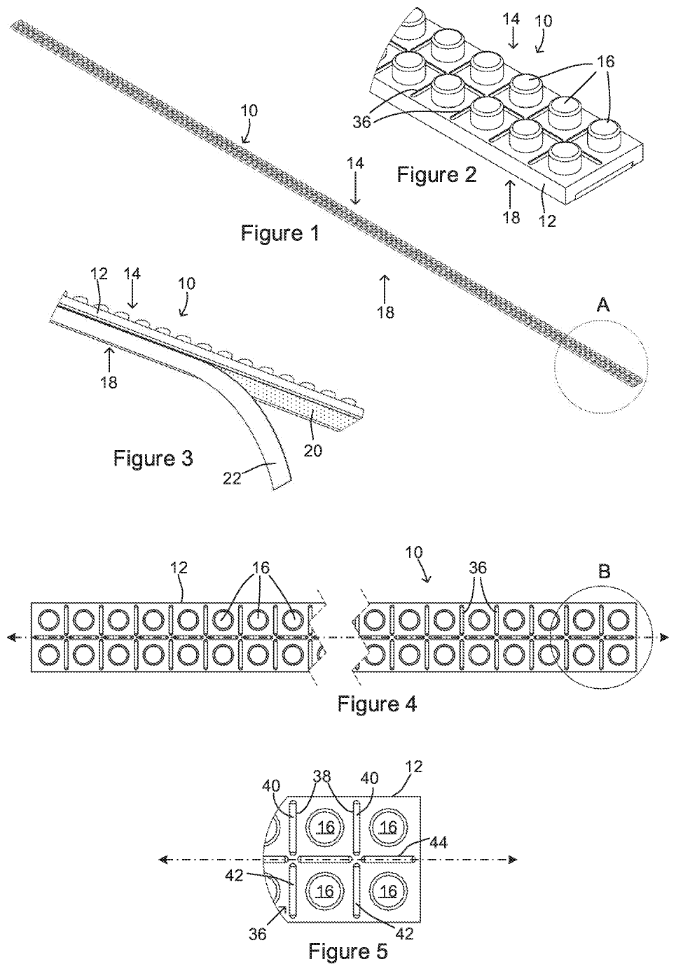

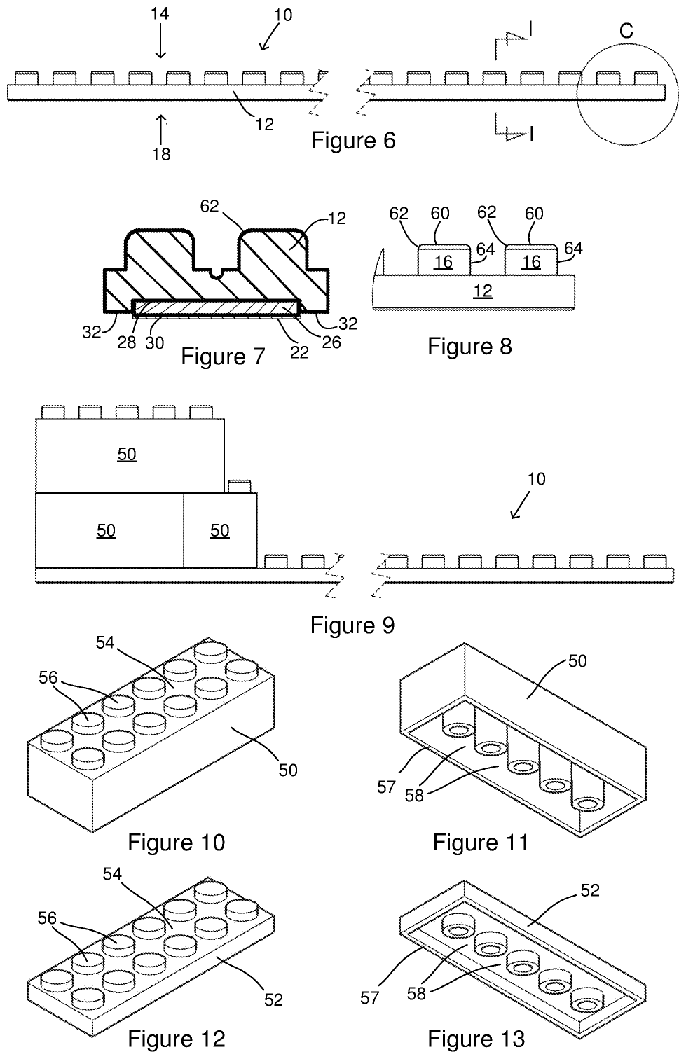

FIGS. 1 to 8 show one embodiment of a toy building block base (10) according to the invention. The toy building block base (10) is in the form of a flexible elongate body strip (12) having a first major surface (14) along a length of the strip with an array of projections (16) extending from the first major surface (14).

The toy building block base (10) is provided for use in association with generally rigid toy building blocks (50, 52) of which two variants are shown in FIGS. 10 to 13, or other co-operant blocks or objects, such as those sold under the trade name LEGO®. Such building blocks (50, 52) have at least one flat surface (54), usually used as the top surface, with multiple projections (56) forming a male mating surface, and an array of recesses (58) that form a female mating surface having a second surface plane (57) from which the recesses extend inwards and usually forming a bottom surface. Different toy building blocks (50, 52) can be frictionally engaged or clipped together with compatible building blocks (50, 52) with at least some of the multiple projections (56) engaging in at least partially overlapped female recesses (58) of another toy building block (50, 52) to form structures of a chosen size, shape and configuration.

Referring back to FIGS. 1 to 8, the first major surface (14) of the toy building block base (10) is an otherwise flat surface so that the array of projections (16) defines a male mating arrangement for co-operant toy building blocks (50, 52). In this embodiment the projections (16) are regularly spaced squat right circular cylindrical projections (16) arranged in adjacent aligned pairs in parallel rows along the length of the flexible elongate body strip (12). In this illustrated embodiment, the strip includes two projections (16) across its width. The flexible elongate body strip (12) has a width that may correspond to the width of at least one form of standard toy building block (50, 52) which may, for example, be 15.8 mm in the case of a standard toy building block (50, 52) with two projections across its width. The invention is not limited to this width, however, and the width may vary between 12 mm and 40 mm with one, two, three or four projections across the width in which case the width of the flexible elongate body strip (12) may correspond to the width of toy building blocks that have the same number of projections across their width. Having the width of the body strip (12) the same as the width of a co-operant toy building block (50, 52) enables strips (12) to be placed adjacent each other to support toy building blocks (50, 52) that span several strips (12).

An opposite, second major surface (18) of the strip has, as illustrated in FIG. 3, a pressure sensitive adhesive (20) that is able to attach the toy building block base (10) to a flat or contoured surface. The pressure sensitive adhesive (20) is covered with a removable cover strip (22) on an exposed face of the adhesive (20) pending initial use. The pressure sensitive adhesive (20) is preferably of a releasable type in order to allow for repositioning of the toy building block base (10) on a supporting surface therefor. This may permit the toy building block base (10) to be peeled off a supporting surface to which it is stuck and then stuck onto another surface in a reusable manner.

The adhesive (20) could be applied directly to the toy building block base (10), but is preferably constituted by one side of a preformed adhesive layer (26) applied to the toy building block base (10) during or after manufacture, as shown in FIG. 7. The second major surface (18) of the toy building block base (10) may be flat in which instance the adhesive (20) only, or the preformed adhesive layer (26), may be applied to the flat second major surface (18). In the illustrated embodiment, however, the adhesive layer (26) is located in a shallow flat-bottomed longitudinal recess (28) in the second major surface (18) of the toy building block base (10). While only one shallow flat-bottomed longitudinal recess (28) is illustrated in these embodiments, it will be appreciated that two or more shallow flat-bottomed longitudinal recesses could extend side-by-side along the length of the body strip, or a number of separate recesses could be formed with bridging portions that extend at regular intervals along the length of the body strip.

The adhesive used to attach the adhesive layer (26) to the toy building block base may be the same as that intended to attach the toy building block base to a supporting surface and it may be applied before the adhesive layer (26) is applied to the toy building block base (10) as it is manufactured. In one embodiment, the adhesive layer (26) is applied as one side of a double sided adhesive polyurethane strip that is located in the shallow flat-bottomed longitudinal recess (28), the depth of which is such that the flat-bottomed longitudinal recess (28) receives a major portion of the thickness of the adhesive layer (26) and an exposed face (30) of the adhesive layer is slightly proud of the edges (32) of the elongate body strip (12) extending along each side of the shallow flat-bottomed longitudinal recess (28), as shown in FIG. 7. The adhesive layer (26) may have a thickness of between 0.4 mm and 0.8 mm with the depth of the flat-bottomed longitudinal recess (28) being slightly less than the thickness of the adhesive layer (26), such as 0.3 mm to 0.7 mm. The adhesive layer (26) and, in this embodiment, the flat-bottomed longitudinal recess (28) are also narrower than the width of the body strip (12) so that the edges (32) form shoulders. The shoulders assist a user to prise the toy building block base (10) off a surface to which it is attached from the side using a finger to curl up the material of the body strip (12) along one side of the strip (12).

Each projection (16) may have a diameter that is slightly larger than a corresponding recess (58) in a cooperating toy building block (50, 52) such that the projection (16) deforms upon being urged into a corresponding recess (58) to create frictional interference between the projection and the cooperating toy block in order to keep the toy block engaged to the toy building block base (10) when it is adhered to an upright or overhead support surface. It is desirable to be able to support not just one block, but an entire block assembly created from interconnected blocks. In this embodiment the projections (16) are cylindrical projections, with each projection having a flat top (60) and a rounded edge (62) between its cylindrical sidewall (64) and its flat top (60) to guide the projection (16) into the corresponding recess (58). In other embodiments, the edge could be chamfered rather than rounded. Simply by way of example, in one product design the projections have an effective outer diameter of 4.95 mm (+1-0.5 mm), a 0.5 mm radius on the rounded edge, and a height of 1.8 mm to provide a surface area around the outside of the projection that contributes to providing a surface friction force that helps keep the block engaged with the toy building block base (10). These projections (16) are adapted to be received in a corresponding recess (58) of a block (50, 52) having an effective diameter of 4.8 mm. That means that in this instance the effective diameter of the projection is about 3% larger than the effective diameter of the recess, but a broader range of between 2 and 5% is also envisaged.

In these embodiments of the invention the engaging projections (16) are circular in plan, but in other embodiments they could be of a different shape in plan view such as square or symmetrical cruciform shape. What is preferred is that the effective diameter of a projection is slightly larger than the effective diameter of a recipient recess and there may be a “lead in” chamfered or rounded top edge to a projection to help guide the projection into the a recipient recess.

The entire flexible elongate body strip (12) of the toy building block base (10) may be made from a homogeneous flexible plastics material such as a thermoplastic rubber (TPR) or polymeric organic silicon compound often referred to as silicones. The material preferably has little plastic memory and most preferably substantially no plastic memory. Such material is sufficiently deformable to bend but rigid enough to support a suitably large assembly of toy building blocks (50, 52) by inter-engagement of the projections (16) of the toy building block base with co-operating recesses (58) of one or more generally rigid toy building blocks (50, 52). The toy building block base (10) is also flexible so that it can flex to follow a three dimensional contour when attached to a supporting surface or structure having a contour other than flat whilst retaining its ability to support multiple toy building blocks (50, 52) or other compatible blocks of special shape. A durometer value of the flexible plastics material of between 35 and 80 is a target range with a preferred value being from 45 to 65 and more preferably being from 50 to 60, according to the ASTM (American Society for Testing and Materials) D2240 standard's type A durometer scale. These durometer values enable the body strip (12) to be severable using a cutting instrument such as a pair of household scissors. The contour may twist and turn to an extent compatible with the positioning of any generally rigid toy building blocks (50, 52) that are to be attached to it. Alternative materials that could be used for the flexible elongate body strip (12) include a paper pulp product that is in a flexible matrix that exhibits appropriate properties of flexibility, or a pulverized or powdered cork product that is in a flexible matrix.

The toy building block base can be made in selected lengths typically within the range of from 200 mm to 3,000 mm, and preferably from 500 mm to 2,500 mm. In the event that the width of the toy building block base is a known width of 15.8 mm, a 1 metre length would correspond to a ratio of width to length of 1:63 for a length of approximately 1 metre; 1:126 for a length of approximately 2 metres; and a ratio of 1:30 for a length of just under a half a metre.

As regards thickness, the toy building block base (10) has a thickness, being the distance between the first and second major surfaces (14, 18), that is at least to a large extent dependent on the material of manufacture and is preferably between 1 mm and 6 mm, and more preferably between 2.5 mm and 4.4 mm. The thickness is selected primarily such that the toy building block base (10) is sufficiently flexible so that it can flex to follow a three dimensional contour by bending and twisting when attached to a supporting surface or structure having a contour other than a flat. The toy building block base must however retain its ability to support co-operant toy building blocks and other co-operant blocks of special shape by way of inter-engaging male and female mating surfaces without the risk that they become easily separated. The thickness is in excess of the height of the cylindrical projections (16) above the flat surface. It will be quite apparent that the thickness is also determined by the sharpness of bend that is to be applied to the toy building block base whilst not distorting the arrangement of projections or recesses excessively so that they retain their functionality.

The first major surface (14) of the flexible elongate body strip (12) may include guide lines (36) that assist a user in cutting the body strip with a cutting instrument such as a pair of scissors. The guide lines (36) are most clearly shown in FIG. 5 and include a set of parallel transverse guide lines (38) that extend across the majority of the width of the body strip (12) at regular spaced intervals between adjacent sets of projections (16) to assist a user in cutting across the width of the body strip (12) at right angles to the length of the strip (12). In this embodiment the regular spaced intervals are between every adjacent projection (16) along the length of the body strip (12) but the regular spaced intervals could be every two, three or four or more sets of projections (16). Each transverse guide line (38) is, in this embodiment, formed by a set of two aligned grooves (40, 42) in the first major surface (14) of the body strip (12), with each individual groove (40, 42) in the set of grooves (40, 42) being consistent with one projection (16). This may assist a user in cutting a distance associated with one projection (16).

The guide lines (36) also include a longitudinal guide line (44) that extends between the two rows of projections (16) along the length of the body strip (12) to assist a user in cutting along the length of the body strip (12). In embodiments in which two, three or four projections (16) extend across the width of the body strip, longitudinal guide lines may extend between each row of projections (16).

In other embodiments, the guide lines may be deeper and may optionally even render the material of the body strip (12) frangible along a guide line by tearing it. Although in FIG. 5 guide lines (36) are shown between every pair of projections (16), guide lines could be provided between any numbers of pairs of projections.

As shown in FIG. 9, the toy building block base (10) is configured to be used together with generally rigid toy building blocks (50) that may form part of a set or may be sold separately. In either event, structures can be built in well-known manner that are supported, in this instance, on the toy building block base (10) of this invention.

Some building block sets with which the toy building block base (10) is to be used may have rather thin building blocks (52) as some of their components that in some instances are referred to as plate building blocks (52). The toy building block base (10) may in such cases have a thickness selected so that its first major surface (14) is at the same height as that of a thin plate building block (52) placed next to it on a common base (70) or other toy building block, as shown in FIG. 14. A structure or assembly of building blocks including standard height toy building blocks (50) and optionally other building blocks can be made to extend partially onto the toy building block base (10) and partly onto a juxtaposed plate building block (52), whilst remaining parallel to a supporting structure (70).

This possibility leads to one embodiment of the invention in the form of a toy building block set including at least one toy building block base (10) according to this invention together with multiple generally rigid standard or other existing toy building blocks (50, 52). The generally rigid toy building blocks (50, 52) may be of various lengths and different heights although the basic building blocks may have two different heights for convenience of construction. Simply for the sake of illustration and completeness of disclosure, FIGS. 10 and 11 illustrate the top and bottom of a standard height of basic building block (50) that has a first major flat surface (54) that can be regarded as a top surface with multiple cylindrical projections (56) forming a male mating surface compatible with those on the toy building block base of this invention. Recesses (58) form a female mating surface on an opposite second major surface plane spaced from the first major surface from which the projections extend by a distance defining a height of the standard toy building block (50).

The arrangement is such that one generally rigid toy building block (50) can be frictionally engaged or clipped together with at least some other generally rigid building blocks (50, 52) with the cylindrical projections of a male mating surface engaging in accommodating recesses (58) in the second major surface of a compatible building block (50, 52) to form composite structures of a chosen size and shape. The toy building block set includes at least one flexible toy building block base (10) as described above for optional use as and when required.

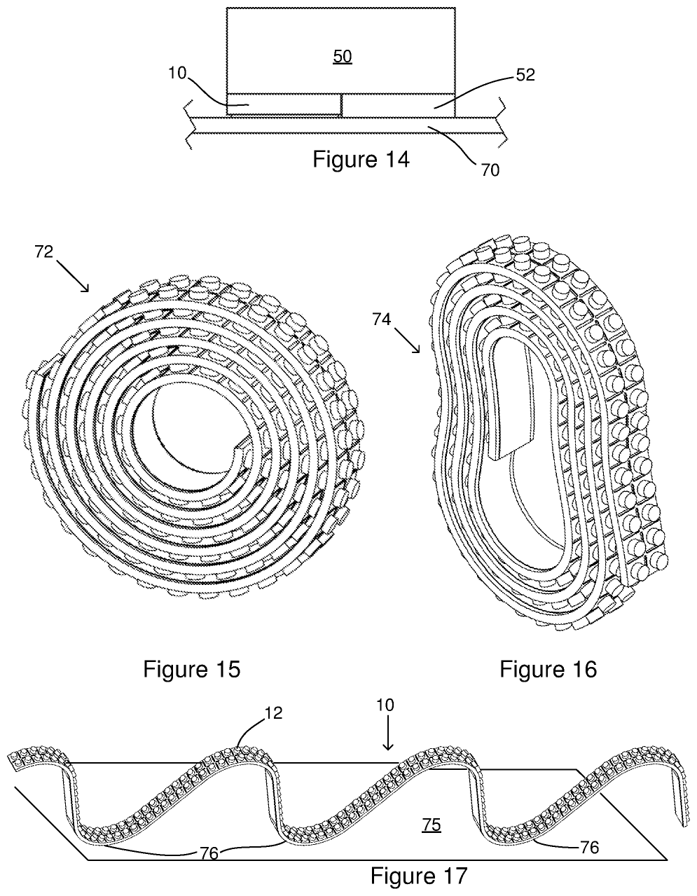

It will be quite apparent that the length of the toy building block base (10) may be considerable and will be chosen according to requirements and according to intended use, as well as sales and promotional strategy. Typically shorter lengths of say 320 mm to 400 mm may be individually packed in wrappers or blister packs whilst longer lengths may be rolled up and wrapped or packed in blister packs. A roll (72) of strip toy building block base is illustrated in FIG. 15 whilst a looped coil package (74) in the fashion of a skein is shown in FIG. 16, simply by way of example. As indicated above, the toy building block base may be made in many different discrete lengths.

The advantageous properties of toy building block bases according to this invention cannot be practically realized without careful product design. The choice of material should be such that bending and flexing of the strip material forming the toy building block base does not significantly alter the positioning and tolerance of the projections or recesses that are to engage with co-operant formations on co-operating toy building blocks to the extent that the building blocks cannot be properly engaged. Also, it is important that positioning and tolerance of the projections or recesses remains substantially unchanged after repeated deformation of the projections or recesses.

As an example, a test may be performed to assess the ability for a block to remain engaged with the toy building block base under the application of a force acting to pull the block apart from the toy building block base. In one such example, a toy building block base (10) having two rows of projections (16) across its width may be affixed to the underside of an overhead horizontal plate. The projections (16) may be of the form described in some preceding exemplary embodiments, with an effective outer diameter of 4.95 mm (+/−0.5 mm), a 0.5 mm radius on the rounded edge, and a height of 1.8 mm, circular in plan. The block is attached to the toy building block base so as to engage with eight of the projections, each being received in a corresponding recess (58) of the block that has an effective diameter of 4.8 mm. The building block can be loaded with metallic weights, such that the weight force acts to pull the block apart from its engagement with the toy building block base. In some embodiments, tested in this manner, the block may be loaded to a weight of 415 grams, and the engagement can support this loading for over 30 seconds. In some embodiments, the inter-engagement of the block and the toy building block base, via eight projections, can support over 400 grams of weight, or at least over 300 grams, when tested in this manner.

The toy building block base (10) is flexible to be manipulated in multiple axes of deformation. This may include: torsional deformation involving twisting of the elongate body strip (12); lateral bending deformation in which the elongate body strip (12) bends in a plane of the strip (12); and longitudinal bending deformation in which the elongate body strip (12) bends in a direction perpendicular to the plane of the strip (12); or any simultaneous combination of these deformations. The flexible material of the toy building block base (10) has sufficient durability to accommodate deformation in multiple directions. The projections (16) may engage recesses (58) of a toy building block (50, 52) such that the blocks (50, 52) remain secured to the building block base (10) during at least some of such deformations.

FIG. 17 shows that the toy building block base (10) is flexible to be manipulated in a longitudinal bending deformation in a direction perpendicular to the plane of the strip (12). As shown, the toy building block base (10) may then be attached to a support surface (75) at a number of zones (76) along the length of the body strip (12) by contacting the adhesive layer (26) of the toy building block base (10) to the support surface (75). The toy building block base (10) is unsupported between the two or more zones (76), and toy building blocks (50), or indeed an entire assembly of toy building blocks (50), may be attached to the toy building block base (10) between the zones (76) in the unsupported areas, so as to create a toy structure supported by the toy building block base (10).

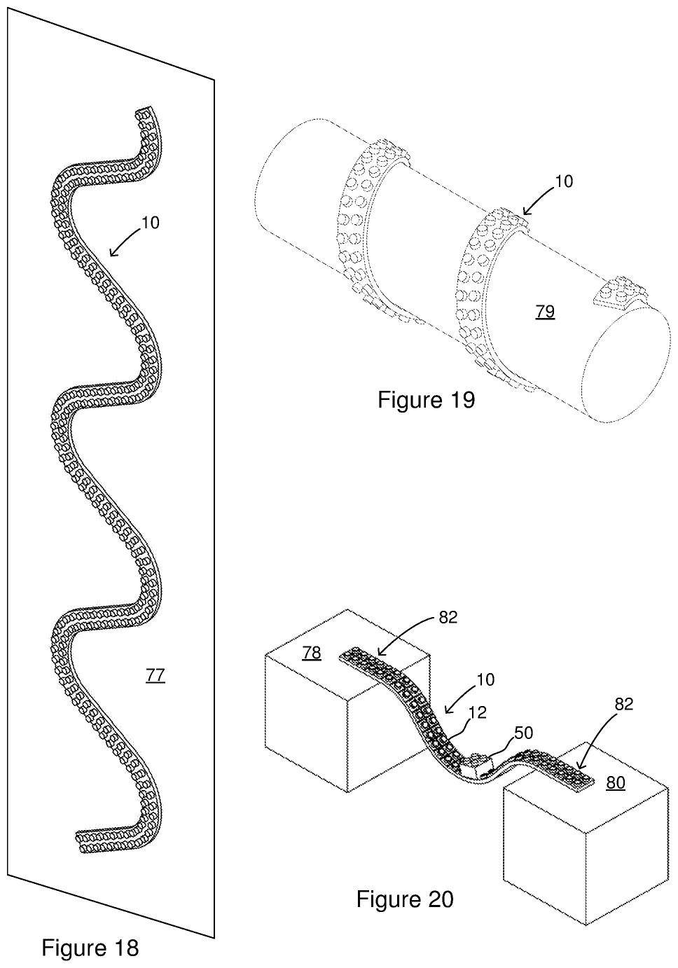

FIG. 18 shows that the toy building block base (10) is flexible to be manipulated in a lateral bending deformation in which the elongate body strip (12) bends in a plane of the strip (12). As shown, the toy building block base (10) may then be attached to a support surface such as, for example, a wall (77), and remain in this curving position by means of the adhesive contacting the support surface along all, or a major portion, of the length of the strip. It will be appreciated that by virtue of the width of the toy building block base (10), the strip (12) may not bend as sharply in this lateral direction as in the longitudinal direction illustrated in FIG. 17.

FIG. 19 shows that the toy building block base (10) is flexible to be manipulated in a torsional deformation involving twisting of the elongate body strip (10) and in a longitudinal bending deformation. In this illustration, the toy building block base (10) is attached in a spiraling configuration around a cylindrical object (79) which may, for example, be a table or chair leg, the handlebars of a bicycle, a cup or glass, to name but a few examples.

FIG. 20 shows a different arrangement where a relatively short length of toy building block base (10) is attached to two separate objects (78, 80) at zones (82) towards its free ends, with a middle part of the toy building block base (10) being unsupported and carrying one or more toy building blocks (50). As can clearly be seen in this illustration, the width of the toy building block base (10) is equal to the width of the toy building block (50).

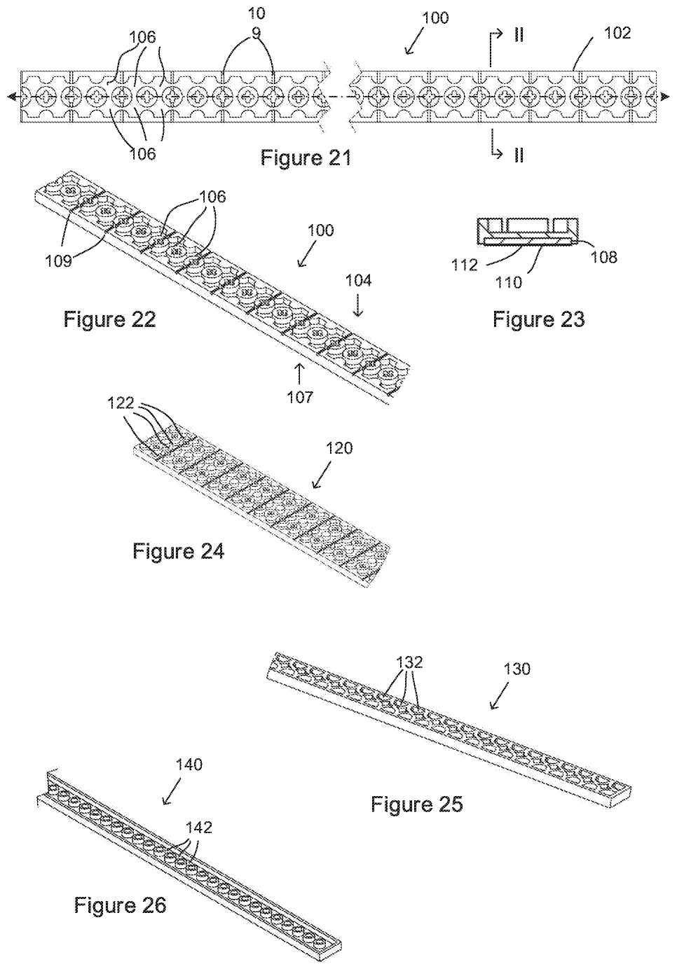

Numerous variations of the toy building block bases fall within the scope of the invention. FIGS. 21 to 23 show a toy building block base (100) that includes a flexible elongate body strip (102) having a first major surface (104) along the length of the strip (102) that includes an array of recesses (106) set into the first major surface (104) forming a female mating arrangement for co-operant toy building blocks (50, 52) or for co-operating with the male mating arrangement of the toy building block base (10) illustrated in FIGS. 1 to 8. Each recess (106) may be formed by multiple surface zones configured to engage portions of the outer periphery of a projection (16, 56) of a toy building block (50, 52) or co-operant toy building block base (10) received therein discontinuously around the surface of the projection (16, 56). This version of the toy building block base (100) may therefore be termed the female or receiver version. As with the male version, the female version of the toy building block base (100) includes a second major surface (107) that has a shallow-bottomed longitudinal recess (108) that receives an adhesive layer (110) which includes a removable cover strip (112) as illustrated in FIG. 22. In this embodiment, guide lines (109) in the form of grooves extend across the width of the strip (112) between every second pair of adjacent recesses (106).

Using male and female versions of toy building block base (10, 100) together leads to the possibilities of their use in a manner akin to hook and loop fastener, where adhesive of the male version can be attached to one object, adhesive of the female version attached to a different object, and the two objects releasably held together by means of the cooperating projections (16) and recesses (106).

The female version of the toy building block base may also be useful in the event that it is desired to build downwards from an overhead or elevated surface.

FIG. 24 shows a version similar to FIG. 22 but which is wider and has four recesses (122) across the width of a toy building block base (120). FIG. 25 shows an alternative arrangement of recesses (132) in a different female version of a toy building block base (130), and one which does not have guide lines and has a flat second major surface without a longitudinal recess. FIG. 26 shows a yet further possible arrangement of recesses (142) in a further female version of a toy building block base (140). It will be appreciated that many other possibilities also exist for the arrangement of the recesses of the female versions.

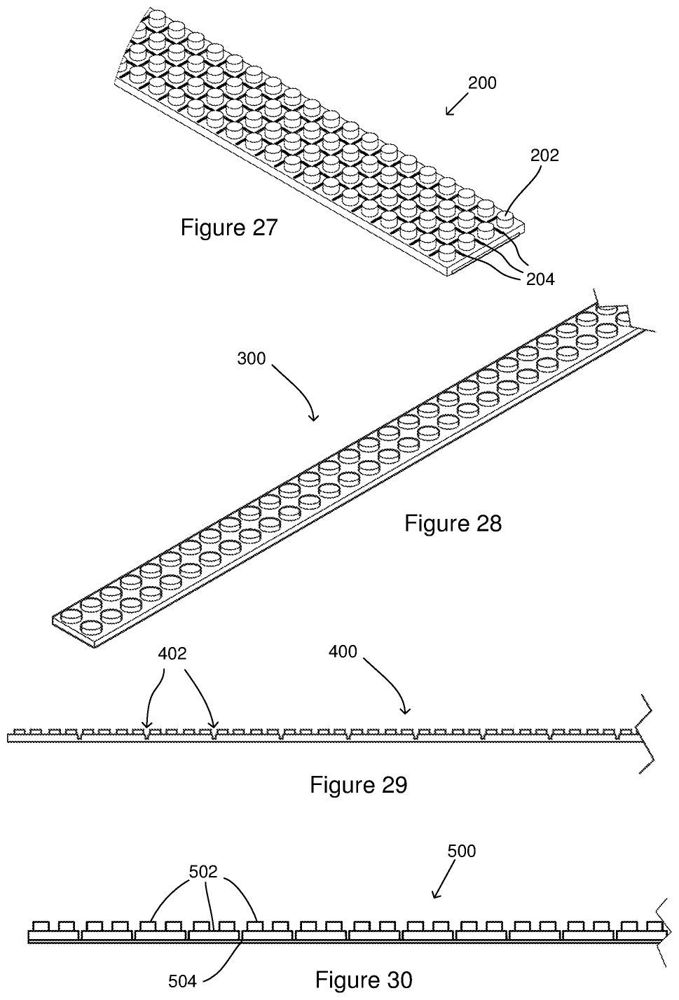

FIG. 27 shows another embodiment of a male version of the toy building block base (200) that has four projections (202) across its width so that it has four longitudinally extending rows of projections (202) so that two standard toy building blocks each having two rows of projections can be accommodated across the width of the toy building block base (200) next to each other or in any other way, or one toy building block having four rows of projections can be accommodated. There is, of course, no restriction as to the orientation in which the co-operating building blocks can be arranged as that is dictated by their geometric arrangement relative to each other. In this embodiment, three elongate guide lines (204) are included between the four rows of projections (202).

FIG. 28 shows another embodiment of a toy building block base (300) which is somewhat simpler and includes a simple flat bottom without a longitudinal recess. In this event an adhesive layer may be thinner and directly applied to the flat bottom. The toy building block base (300) is also devoid of any guide lines.

As an alternative to the use of the inherent flexibility of a single thickness of the material from which the toy building block base is made, and as shown in FIG. 29, the thickness of the material may be decreased between selected pairs of adjacent projections. In the instance illustrated in FIG. 29, a toy building block base (400) is shown that has decreased zones (402) provided after every four pairs of projections that would correspond to a standard toy building block having four pairs of projections. These zones of decreased thickness provide what is known as living hinges between the adjacent zones that each have four pairs of projections so that greater flexibility is provided at the living hinges with limited flexibility between adjacent living hinges. Of course, these zones of decreased thickness may simply be grooves that could, in addition, serve as cutting or tearing guide lines.

FIG. 30 illustrates a construction of toy building block base (500) in which a multitude of short lengths (502) of building block base are carried by a flexible tape (504) rendering the toy building block base flexible as described above.

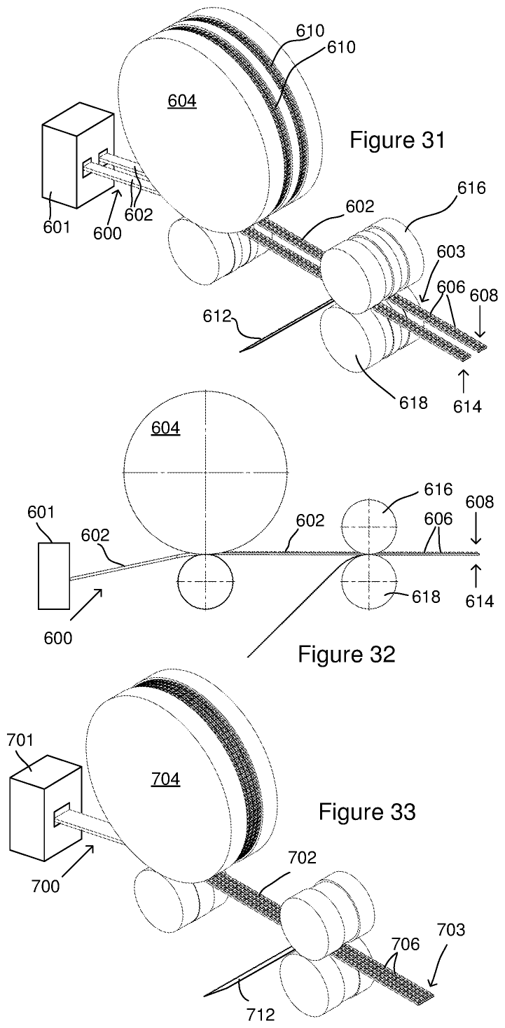

FIGS. 31 and 32 illustrate a method of manufacturing a toy building block base according to an embodiment of the invention. A plastics material that has the properties previously discussed above is extruded by means of an extrusion die (601) into an extrusion (600). In this embodiment, two extrusions (600) are formed side-by-side. The extrusions (600) form elongate body strips (602) that are then roll formed prior to the plastics material hardening by using a roller mould (604) that presses the elongate body strips (602) to include either an array of projections (606) or an array of recesses (in the case of a female version of the product) in a first major surface (608) of each body strip (602). In this example, the roller mould (604) has a pair of tracks (610) therein that form the mould for the projections or recesses of the body strips (602).

A polyurethane adhesive layer (612) is thereafter continuously applied to an opposite, second major surface (614) along the length of each body strip (602) and pressed into place by a pair of rollers (616, 618) to form a toy building block base (603) of the type in FIGS. 1-8. The body strip (602) may include a shallow flat-bottomed longitudinal recess in the second major surface (614) as previously described into which the adhesive layer (612) fits so that an exposed face of the adhesive layer is slightly proud (such as 0.1 mm to 0.5 mm proud) of the edges of the elongate body strip. The longitudinal recess is preferably formed by the extrusion die so that it is included in the extrusion (600). Prior to the adhesive layer being applied, the flat-bottomed longitudinal recess in the second major surface (614) may be primed or treated with a solvent in order to prepare it for bonding to the adhesive and enhance the bond of the adhesive to the body strip (602) to create a permanent bond. An exposed face of the adhesive layer (612) may be covered with a cover strip pending initial use and the adhesive layer (612) may be reusable in that it can be peeled off a surface to which it is stuck and then be stuck onto another surface in reusable manner.

As a final step, the continuously formed body strips (602) are then then severed into selected lengths which are typically greater than 200 mm but may be from 200 mm to 3,000 mm, and preferably from 500 mm to 2,500 mm.

FIG. 33 is similar to FIG. 31 but shows a single, wider extrusion (700) that emerges from an extrusion die (701) and is rolled with a roller mould (704) into a body strip (702) that has four projections (706) across its width, and an adhesive layer (712) applied to form a toy building block base (703) of the type illustrated in FIG. 26.

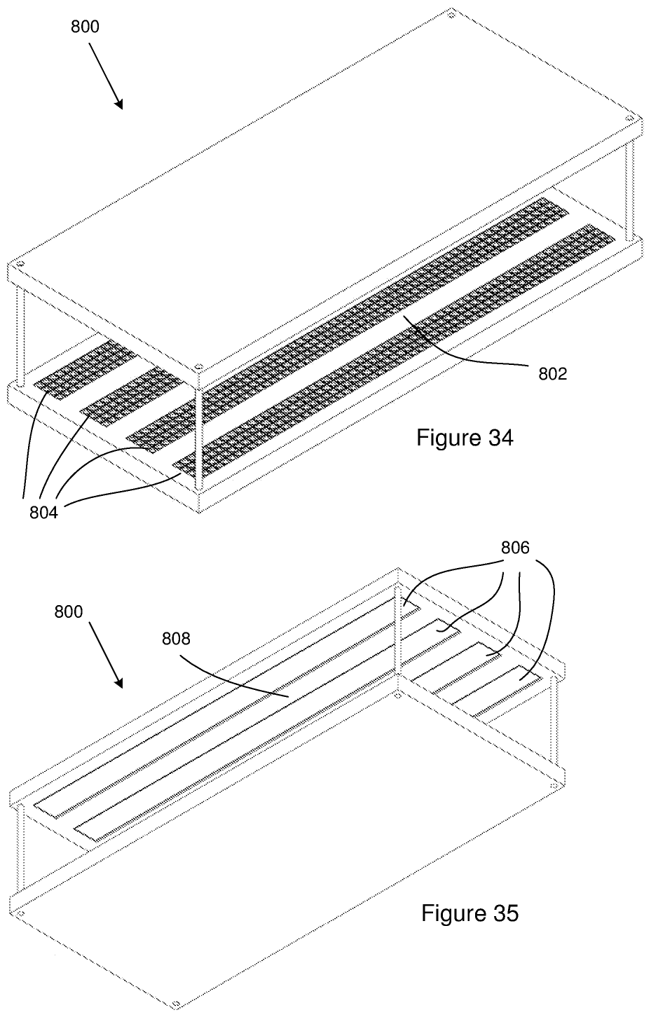

FIGS. 34 and 35 show a method of manufacturing a toy building block base by means of compression moulding according to a different embodiment. A sheet of plastics material that has the properties previously described is cut into strips and the strips placed onto a lower surface (802) of a compression moulding machine (800) with each strip placed on top of an elongate recess (804) in the lower surface that forms one half of a mould cavity that has internal surfaces shaped to mould either an array of projections or an array of recesses into a first major surface of the strip of flexible plastic material. The other half of each mould cavity is an opposite elongate recess (806) in an upper surface (808) of the mould. In this embodiment, the toy building block bases to be compression moulded are male versions having four projections across their width. The mould cavity has a length of at least 200 mm.

The upper surface (808) preferably has a backing sheet (not shown) attached to it. The upper and lower surfaces are heated, for example to 195° C. (±10° C.) in one embodiment, and the upper surface (808) of the moulding machine (800) is then pressed against the lower surface to compress the strips in the mould cavity. Each strip of material then takes on the shape of its mould and is allowed to set. Once set the mould is then opened by moving the upper and lower surfaces apart. The backing sheet remains attached to the moulded strips and is used to remove all of the strips from the lower surface (802) of the compression moulding machine and out of the machine. In a separate process, the strips are then removed from the backing sheet and fed successively into a roller which applies the adhesive layer onto each strip in a continuous manner.

There are numerous uses for the toy building block base according to the invention as will be quite apparent to those skilled in the art. The toy building block base can be stuck onto any suitable surface such as that of a wall, window, undulating surfaces such as the handlebars of a bicycle, the upper of a shoe, a toy or any other three-dimensional shaped surface such as the outer surface of a motor vehicle, motorbike, and numerous other different surfaces. The surface can involve twisting, turning and bending to an extent permissible by the flexibility of the toy building block base and the particular arrangement of rigid toy building blocks with which the toy building block base is to be used. In all instances the toy building block base can be used to create a bridge from one surface to another or even a sinuous wave-like structure supported on only its trough sections as shown in FIG. 17 or suspended from its peak sections in the case of an overhead support surface. The configuration of the accommodating recesses may vary widely. As regards manufacturing, another method of manufacturing the toy building block base is by injection moulding the relevant material.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

The embodiments discussed herein are representative of preferred embodiments of the present invention and are provided for illustrative purposes only. They are not intended to limit the scope of the invention. Although specific configurations, structures, materials, etc. have been shown and described, such are not limiting. Modifications and variations are contemplated within the scope of the invention.

1-20. (canceled)

21. A toy building block base comprising:
a flexible body strip having an elongated dimension and a first major surface along a length of the flexible body strip in the elongated dimension between longitudinal edges of the flexible body strip, the flexible body strip having a second major surface opposite the first major surface, the flexible body strip having a width dimension between the longitudinal edges, and the flexible body strip having a center axis that extends along the length of the flexible body strip equidistant between the longitudinal edges;
an array of either projections extending from the first major surface or of recesses set into the first major surface and consisting of aligned pairs of projections or recesses regularly spaced across the width dimension of the flexible body strip between the longitudinal edges of the flexible body strip and forming two evenly spaced parallel rows of projections or recesses along the length of the flexible body strip on the first major surface, the center axis extending equidistant between the two rows of projections or recesses, and the projections or recesses forming a mating arrangement for use with a co-operant toy building block having two rows of accommodating recesses or projections across a width of the co-operant toy building block; and
a longitudinal adhesive layer on the second major surface by which the flexible body strip can be attached to a support surface, wherein:
the flexible body strip has a length of at least 200 mm and the parallel rows of projections on the first major surface extend substantially the entire length of the flexible body strip;
the width of the flexible body strip corresponds to the width of the co-operant toy building block; and
the entire flexible body strip is made from a homogenous flexible material, flexible in a three dimensional contour by twisting about the center axis, lateral bending in a plane of the flexible body strip, and longitudinal bending in a direction perpendicular to the plane of the flexible body strip, while maintaining the mating arrangement with the co-operant toy building block.

22. A toy building block base as claimed in claim 21, wherein the array of either projections extending from the first major surface or of recesses set into the first major surface is the array of recesses set into the first major surface.

23. A toy building block base as claimed in claim 21 in which the second major surface has a shallow flat-bottomed longitudinal recess and the adhesive layer is a pre-formed adhesive layer that is received in the shallow flat-bottomed longitudinal recess with a major portion of a thickness of the pre-formed adhesive layer being received in the flat-bottomed longitudinal recess.

24. A toy building block base as claimed in claim 23, wherein the flat-bottomed longitudinal recess is narrower than the width dimension of the flexible body strip, defining shoulders in the second major surface and the adhesive layer extends proud of the shoulders of the second major surface from the shallow flat-bottomed longitudinal recess.

25. A toy building block base as claimed in claim 21 in which the adhesive layer is a double sided adhesive polyurethane strip and is reusable to permit the toy building block base to be peeled off a surface to which it is stuck and then be stuck onto another surface in a reusable manner.

26. A toy building block base as claimed in claim 21 having a length of from 500 mm to 2,500 mm, and wherein the toy building block base is packaged as a roll.

27. A toy building block base as claimed in claim 21 in which the flexible material has a durometer value according to the ASTM D2240 standard's type A durometer scale from 45 to 65 and the toy building block base is severable by cutting with a pair of household scissors.

28. A toy building block base as claimed in claim 21, wherein the array of either projections extending from the first major surface or of recesses set into the first major surface is the array of projections extending from the first major surface.

29. A toy building block base as claimed in claim 28, wherein each projection of the aligned pair of projections in the array of projections is equidistant from the center axis and a longitudinal edge of the flexible body strip.

30. A toy building block base as claimed in claim 28, in which the flexible body strip has a thickness defined between the first major surface and second major surface that is greater than the height of the projections extending above the first major surface.

31. A toy building block base as claimed in claim 28 in which each projection has a diameter that is between 2 and 5 percent larger than a corresponding recess in the co-operant toy building block such that the projection deforms upon being urged into the corresponding recess to create frictional interference between the projection and the corresponding co-operant toy building block.

32. A toy building block base as claimed in claim 31 in which each projection is a squat right circular projection with a flat top and a rounded or chamfered edge between its cylindrical sidewall and its flat top to guide the projection into a corresponding recess in a cooperating toy block.

33. A toy building block base as claimed in claim 28, wherein each of the projections of each aligned pair of projections are separated by an interval distance and the aligned pairs of projections separated from adjacent aligned pairs of projections by the interval distance and each projection has an associated portion of the flexible body strip surrounding the projection and extending in the length dimension and the width dimension for the interval distance, wherein the combined associated portions of the flexible body strip of each aligned pair extend for the width of the flexible body strip between the longitudinal edges of the flexible body strip.

34. A toy building block base as claimed in claim 28 in which guide lines are provided in the first major surface of the flexible body strip, the guide lines include a set of parallel transverse grooves that extend at least partway across the width of the flexible body strip at regular spaced intervals between adjacent sets of projections or recesses to assist a user in cutting across the width of the flexible body strip at right angles to the length of the flexible body strip.

35. A toy building block base as claimed in claim 34 in which the guide lines include one or more longitudinal grooves that extend between rows of projections or recesses along the length of the flexible body strip to assist a user in cutting along the length of the flexible body strip.

36. A toy building block base as claimed in claim 34 in which each guide line includes a set of aligned grooves, with each individual groove in the set of grooves is consistent with one projection or recess so that the ease of cutting with a cutting instrument changes each time a user cuts a distance associated with one projection or recess.

37. A toy building block set comprising:
at least one toy building block base as claimed in claim 21; and
multiple toy building blocks which each comprise a first major surface with an array of projections forming a male mating surface and an array of recesses comprising two rows of accommodating recesses across a width of the toy building block forming a female mating surface, with the recesses extending inwards from a second opposite major surface plane spaced from the first major surface by a distance defining a height of the toy building block, wherein one toy building block can be frictionally engaged together with another toy building block by at least some of the projections of a male mating surface engaging in recesses in a female mating surface of the other building block to form composite structures of a chosen size and shape;
wherein the width of the toy building blocks match the width dimension of the flexible body strip of the at least one toy building block base; and
wherein when each toy building block of the toy building block set is secured by a friction fit between the aligned pairs of projections or recesses of the flexible body strip and the toy building block, the mating arrangement is maintained through three-dimensional deformation by bending and twisting of the flexible body strip.

38. The toy building block set of claim 37, wherein the at least one toy building block base comprises a first toy building block base and a second toy building block base, wherein the first toy building block base and the second toy building block base are arranged in contact with one another on a support surface with the first major surface of the first toy building block base coplanar to the first major surface of the second toy building block base, and the toy building block of the toy building block set is simultaneously secured by friction fit to the first toy building block base and the second toy building block base.

39. A toy building block set as claimed in claim 37, wherein the at least one toy building block base comprises a first toy building block base and the multiple toy building blocks comprises a plate building block, wherein the flexible body strip of the first toy building block base has a thickness defined between the first major surface and the second major surface that matches a thickness of the plate building block defined between its first major surface and second major surface, and wherein the first toy building block base and the plate building block are positioned on a support surface in contact with one another with the first major surface of the first toy building block base coplanar to the first major surface of the plate building block, and the co-operant toy building block of the multiple toy building blocks is simultaneously secured by friction fit to the first toy building block base and the plate building block.

40. A method of constructing a toy structure using the toy building block set of claim 37, the method comprising attaching the toy building block base to a support surface at two or more zones along the length thereof by contacting the adhesive layer of the toy building block base to the support surface, the toy building block base being unsupported between the two or more zones, and attaching a plurality of co-operant toy building blocks to the toy building block base between the zones in the unsupported areas so as to create a toy structure supported by the toy building block base.
